(19) United States
(12) Patent Application Publication
(10) Pub. No.: US 2005/0061038 A1
(43) Pub. Date: Mar. 24, 2005

(54) Shackle locks with a removable shackle

(75) Inventors: Renny Tse-Haw Ling, Taipei Hsien (TW); Jia-Hwa Sun, Taipei Hsien (TW)

Correspondence Address: Finnegan, Henderson, Farabow,;Garrett & Dunner, L.L.P., 1300 I Street, N.W., Washington, DC, 20005-3315, US

(73) Assignee: Sinox Co., Ltd.

(21) Appl. No.: 10/667,458

(22) Filed: Sep. 23, 2003

(51) Int. Cl. E05B 37/02

(52) U.S. Cl. 70/30

(57) ABSTRACT

A shackle lock that comprises a housing, a shackle further comprising a first end and a second end, a first connecting member formed at the first end, a second connecting member formed at the second end, a first shackle hole corresponding to the first connecting member, and a second shackle hole corresponding to the second connecting member, wherein the first connecting member passes through the second shackle hole when removing the shackle from the housing.

### DESCRIPTION OF THE INVENTION

1. Field of the Invention

This invention relates in general to locks, and more particularly, to a lock including a housing and a shackle removable from the housing.

2. Background of the Invention

A shackle lock or padlock generally includes a housing and a shackle. According to a conventional technique in the art, one end of a shackle is kept between a locked position and an unlocked position by a locking mechanism formed in the housing, while the other end of the shackle is fixed to the housing. Such a shackle lock does not provide a replaceable shackle. In another conventional technique in the art, both ends of the shackle are removable from the housing. Such a shackle lock, however, may include a more complicated locking mechanism than that without a replaceable shackle.

Due to increased security measures, customs world wide have conducted a more intensive security check. Some customs officers may destroy the locks of baggage for a security check. For a shackle lock, the shackle is often the damage spot, and the housing or locking mechanism may be left intact. A lock with a replaceable shackle in that case has an advantage that only a new shackle is needed instead of a new lock. Besides, locks may become accessories for young women. A replaceable shackle lock provides the advantage of fashion variety. There is thus a need in the art for a shackle lock designed to include the advantages of replacaeable shackles without modifying any locking mechanisms.

### SUMMARY OF THE INVENTION

Accordingly, the present invention is directed to a shackle lock that obviates one or more of the problems due to limitations and disadvantages of the related art.

To achieve these and other advantages, and in accordance with the purpose of the invention as embodied and broadly described, there is provided a shackle lock that comprises a housing, a shackle further comprising a first end and a second end, a first connecting member formed at the first end, a second connecting member formed at the second end, a first shackle hole corresponding to the first connecting member, and a second shackle hole corresponding to the second connecting member, wherein the first connecting member passes through the second shackle hole when removing the shackle from the housing.

In one aspect, the second shackle hole has a diameter greater than that of the first connecting member, and smaller than that of the second connecting member.

In another aspect, the lock further comprises a protruding member extending from the housing.

Also in accordance with the present invention, there is provided a shackle lock that comprises a housing, a shackle further comprising a first end and a second end, a first shackle hole, and a second shackle hole allowing the first end to pass in a first direction, and blocking the second end to pass in a second direction substantially opposite to the first direction.

Still in accordance with the present invention, there is provided a shackle lock that comprises a housing, at least one protruding member extending from the housing, a shackle further comprising a first end and a second end, a first connecting member formed at the first end having a first diameter, a second connecting member formed at the second end having a second diameter, a first shackle hole corresponding to the first connecting member, and at least one second shackle hole corresponding to the second connecting member, each of the at least one second shackle hole having a diameter greater than the first diameter and smaller than the second diameter.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawing, which is incorporated in and constitutes a part of this specification, illustrates several embodiments of the invention and together with the description, serves to explain the principles of the invention.

### BRIEF DESCRIPTION OF THE DRAWINGS

FIGS. 1A to 1F show perspective views of a lock in accordance with one embodiment of the present invention;

FIG. 2 is a perspective view of a lock in accordance with another embodiment of the present invention;

FIG. 3 is a perspective view of a lock in accordance with yet another embodiment of the present invention; and

FIG. 4 is a perspective view of a lock in accordance with still another embodiment of the present invention.

### DESCRIPTION OF THE EMBODIMENTS

Reference will now be made in detail to the present embodiment of the invention, an example of which is illustrated in the accompanying drawings.

Wherever possible, the same reference numbers will be used throughout the drawings to refer to the same or like parts.

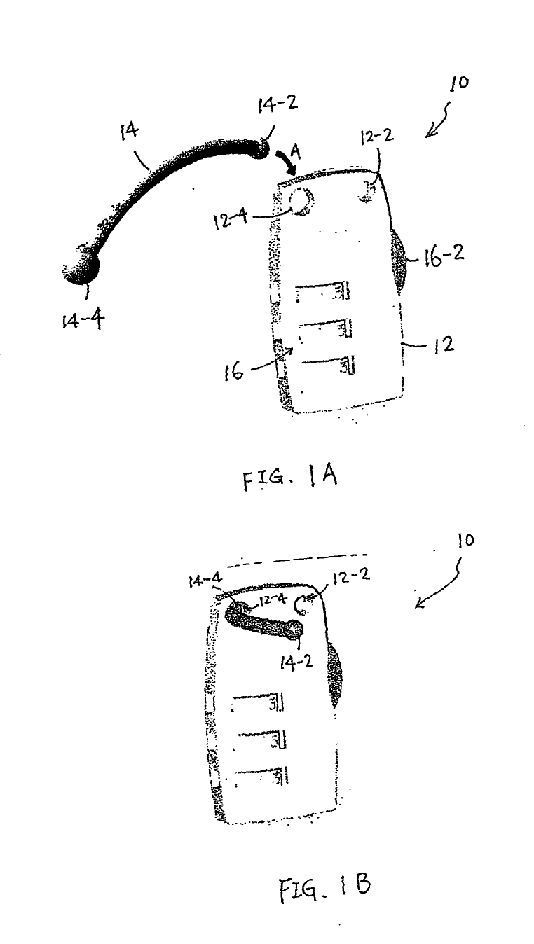

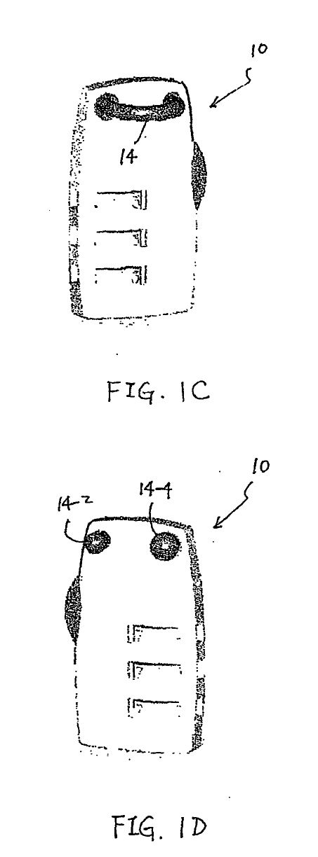

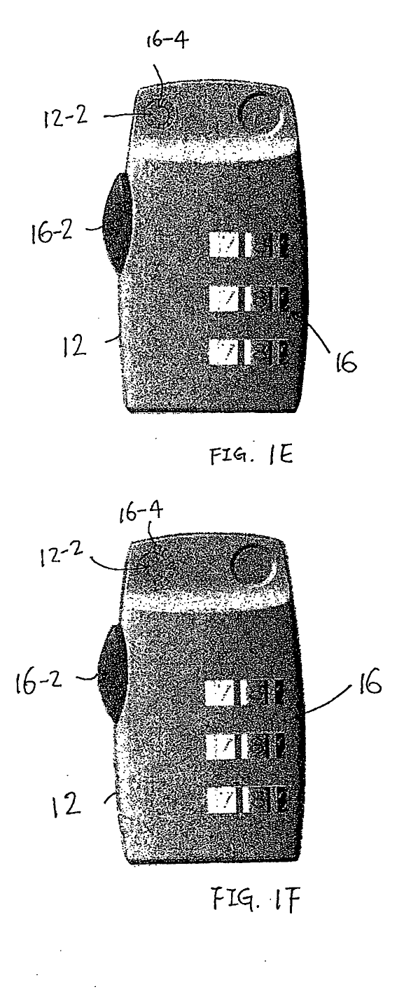

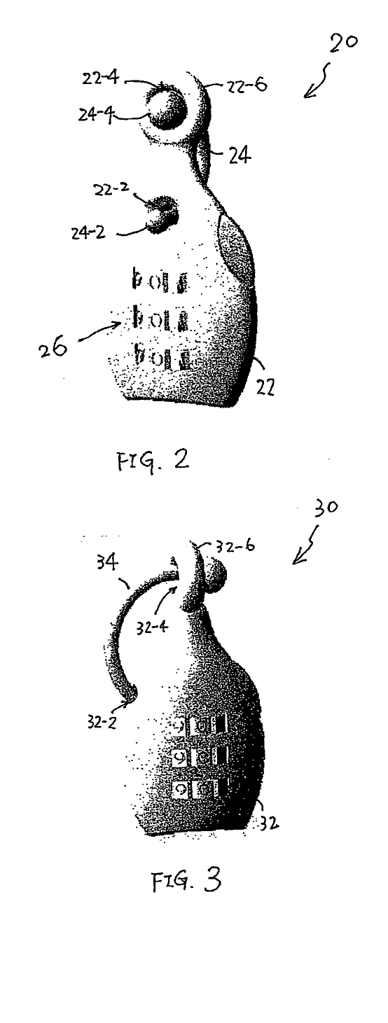

FIGS. 1A to 1F show a perspective view of a lock 10 in accordance with one embodiment of the present invention. Referring to FIG. 1A, lock 10 includes a housing 12 and a shackle 14. Shackle 14 includes an elongated, flexible cable. In one embodiment according to the invention, shackle 14 may include a U-shaped rigid material. Shackle 14 includes a first end (not numbered) and a second end (not numbered). A first connecting member 14-2 and a second connecting member 14-4 are respectively formed at the first end and second end of shackle 14. First connecting member 14-2 has a diameter smaller than that of second connecting member 14-4. In one embodiment according to the invention, first connecting member 14-2 and second connecting member 14-4 include a cable connecting head.

Housing 12 includes a first shackle hole 12-2 corresponding to first connecting member 14-2, and a second shackle hole 12-4 corresponding to second connecting member 14-4. In this particular embodiment according to the invention, first shackle hole 12-2 and second shackle hole 124 are through holes formed in housing 12. Second shackle hole 12-4 has a diameter greater than that of first connecting member 14-2, and smaller than that of second connecting member 14-4.

Lock 10 further includes a locking member 16 to keep the first end of shackle in a locked position or an unlocked position. Locking member 16 includes a combination locking mechanism (not shown) that allows the release of shackle 14 from a locked position by entering a set of numbers, i.e., the number combination, to lock 10. Locking member 16 may further include a button 16-2 formed in housing 12 to help release shackle 14 when the number combination is entered. In one embodiment according to the invention, locking member 16 may include a key-operated locking mechanism which allows a user to open lock 10 by a key.

In operation, first connecting member 14-2 is inserted into second shackle hole 12-4 in a first direction shown in an arrow A. Then, referring to FIG. 1B, first connecting member 14-2 passes through second shackle hole 12-4 toward first shackle hole 12-2. Having a greater diameter than that of second shackle hole 12-4, second connecting member 144 is locked outside second shackle hole 12-4 as viewed from a second direction substantially opposite to the first direction. Referring to FIG. 1C, first connecting member 14-2 is inserted into first shackle hole 12-2 to lock the lock 10. FIG. 1D shows a rear side view of lock 10 shown in FIG. 1C.

To remove shackle 14 from housing 12, a user unlocks first connecting member 14-2 from a locked position, and pulls first connecting member 14-2 out of second shackle hole 124 in the second direction.

In one embodiment according to the invention, second connecting member 144 is engaged with second shackle hole 12-4 in a magnetic manner by, for example, providing a magnet in second shackle hole 12-4 to attract second connecting member 14-4. In another embodiment according to the invention, second connecting member 14-4 is engaged with second shackle hole 12-4 in a bolt-and-thread manner where threads are provided in second shackle hole 12-4 and second connecting member 14-4.

In one embodiment according to the invention, first connecting member 14-2 is engaged in first shackle hole 12-2 by a removable block 16-4, as shown in FIGS. 1E and 1F. Referring to FIGS. 1E and 1F, removable block 16-4 is formed in housing 12, and removable between a first position (FIG. 1E) to block first connecting member 14-2 and a second position (FIG. 1F) to release first connecting member 14-2 by, for example, entering the number combination to locking mechanism 16 and pushing button 16-2.

FIG. 2 shows a perspective view of a lock 20 in accordance with another embodiment of the present invention. Referring to FIG. 2, lock 20 includes a housing 22, a shackle 24, and a locking member 26. Shackle 24 includes a first connecting member 24-2 formed at one end, and a second connecting member 24-4 formed at the other end of shackle 24. Second connecting member 24-4 has a diameter greater than that of first connecting member 24-2. Housing 22 includes a protruding member 22-6 extending from housing 22, a first shackle hole 22-2 being a through hole formed in housing 22, and a second shackle hole 22-4 formed in protruding member 22-6. The operation and function of lock 20 are generally the same as those of lock 10 shown in FIGS. 1A to 1D, and are not repeated herein.

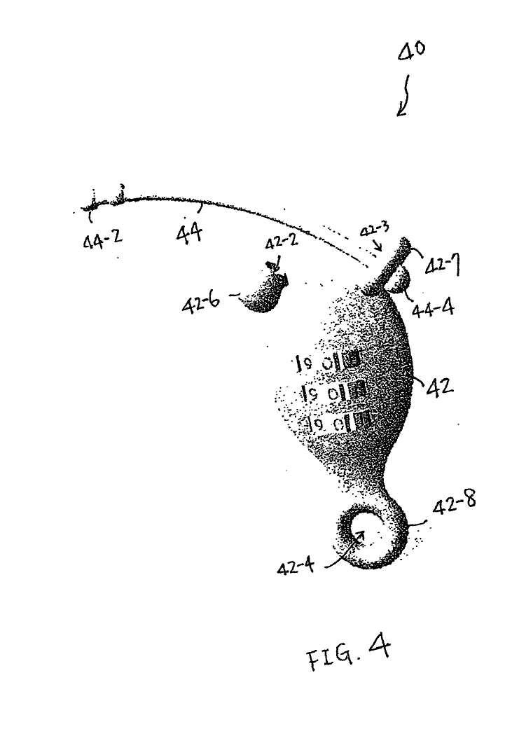

FIG. 3 is a perspective view of a lock 30 in accordance with yet another embodiment of the present invention. Referring to FIG. 3, lock 30 includes a housing 32 and a shackle 34. Housing 32 includes a protruding member 32-6 extending from housing 32, a first shackle hole 32-2 being an opening formed in housing 32, and a second shackle hole 32-4 formed in protruding member 32-6. Protruding member 32-6 is rotatable with respect to housing 32.

FIG. 4 is a perspective view of a lock 40 in accordance with still another embodiment of the present invention. Referring to FIG. 4, lock 40 includes a housing 42 and a shackle 44. Housing 42 includes a first protruding member 42-6, a second protruding member 42-7, and a third protruding member 42-8 extending from housing 42. Housing 42 further includes a first shackle hole 42-2 formed in first protruding member 42-6, a second shackle hole 42-3 formed in second protruding member 42-7, and a third shackle hole 42-4 formed in third protruding member 42-8. Each of the second shackle hole 42-3 and third shackle hole 424 has a diameter greater than that of a first connecting member 44-2 of shackle 44, and smaller than that of a second connecting member 44-4 of shackle 44.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A shackle lock comprising:
a housing;
a shackle further comprising a first end and a second end;
a first connecting member formed at the first end;
a second connecting member formed at the second end;
a first shackle hole corresponding to the first connecting member; and
a second shackle hole corresponding to the second connecting member;
wherein the first connecting member passes through the second shackle hole when removing the shackle from the housing.

2. The lock of claim 1 further comprising a locking member formed in the housing.

3. The lock of claim 1, the second shackle hole having a diameter greater than that of the first connecting member, and smaller than that of the second connecting member.

4. The lock of claim 1 further comprising a protruding member extending from the housing.

5. The lock of claim 4, the protruding member being rotatable with respect to the housing.

6. The lock of claim 1 further comprising a first protruding member and a second protruding member extending from the housing, wherein the first and the second shackle holes are respectively formed in the first and the second protruding members.

7. The lock of claim 6 further comprising a third protruding member extending from the housing, wherein a third shackle hole is formed in the third protruding member.

8. The lock of claim 1, the second connecting member engaging the second shackle hole in a magnetic manner.

9. The lock of claim 1, the second connecting member engaging the second shackle hole in a bolt-and-thread manner.

10. The lock of claim 9, the shackle further comprising an elongated flexible cable.

11. A shackle lock comprising:
a housing;
a shackle further comprising a first end and a second end;
a first shackle hole; and
a second shackle hole allowing the first end to pass in a first direction, and blocking the second end to pass in a second direction substantially opposite to the first direction.

12. The lock of claim 11 further comprising:
a first connecting member formed at the first end; and
a second connecting member formed at the second end;
wherein the second shackle hole includes a diameter greater than that of the first connecting member, and smaller than that of the second connecting member.

13. The lock of claim 11 further comprising a protruding member extending from the housing.

14. The lock of claim 13 wherein the first and second shackle holes are formed in the protruding member.

15. The lock of claim 13, the protruding member is rotatable with respect to the housing.

16. A shackle lock comprising:
a housing;
at least one protruding member extending from the housing;
a shackle further comprising a first end and a second end;
a first connecting member formed at the first end having a first diameter;
a second connecting member formed at the second end having a second diameter;
a first shackle hole corresponding to the first connecting member; and
at least one second shackle hole corresponding to the second connecting member, each of the at least one second shackle hole having a diameter greater than the first diameter and smaller than the second diameter.

17. The lock of claim 16 further comprising a locking member formed in the housing.

18. The lock of claim 17, the locking member further comprising a number combination.

19. The lock of claim 16 wherein the first shackle hole and the second shackle hole are formed in the at least one protruding member.

20. The lock of claim 16, the at least one protruding member being rotatable with respect to the housing.
